(19) United States
(12) Patent Application Publication
(10) Pub. No.: US 2016/0005045 A1
(43) Pub. Date: Jan. 7, 2016

(54) SYSTEM TO ACCEPT AN ITEM OF VALUE

(71) Applicant: MEI, Inc., Malvem, PA (US)

(72) Inventors: Neil YOUNG, Downingtown, PA (US); Gaston BAUDAT, Glenmoore, PA (US)

(73) Assignee: MEI, Inc., Malvern, PA (US)

(21) Appl. No.: 14/770,421

(22) PCT Filed: Feb. 20, 2014
(86) PCT No.: PCT/US14/17339

§ 371 Date: Aug. 25, 2015

Related U.S. Application Data
(60) Provisional application No. 61/768,741, filed on Feb. 25, 2013.

(51) Int. Cl. G06Q 20/40; G07F 7/04; G07D 11/00

(52) U.S. Cl. CPC G06Q 20/4016; G06Q 20/405; G07D 11/0066; G07F 7/04

(57) ABSTRACT

A system comprising a classification module and a scoring module is described herein. The classification module is configured to configured to classify at least one item of value into at least one class in response to a user activity; and the scoring module configured to determine an acceptance score based at least on transactional data and associate an action with the user activity corresponding to the acceptance score.

### RELATED APPLICATIONS

This application claims priority to U.S. Provisional Patent Application No. 61/768,741 filed Feb. 25, 2013, the contents of which are hereby incorporated by reference in its entirety.

### TECHNICAL FIELD

The present subject matter relates, in general, to handling of media in an electronic transaction system and, in particular, to a method and a system for accepting one or more items of value, such as coins, tokens, banknotes, bills, valuable papers, security documents, currency, etc., inserted into the electronic transaction system.

### BACKGROUND

Typically, electronic transaction systems, such as vending machines, electronic gaming devices, and other electronic acceptors, receive and dispense items of value such as, coins, token, valuable documents, coupons, and banknotes in response to user activity. The systems include discriminators to determine the authenticity of the inserted items of value. Typically, discriminators include one or more sensors to measure one or more properties of the items of value, such as dimensions, conductivity, and magnetic permeability, for authentication and/or recognition purposes. Data from sensors is used to determine whether the inserted item of value meets predefined acceptance criteria for one of suspect counterfeit media or genuine item. Accordingly, the electronic transaction system either accepts or rejects/impounds the item of value.

However, the item may be an unfit item of value, e.g., taped, soiled, cut, torn, etc. The unfit items may or may not have value. Typically, the acceptance criteria are very stringent for unfit items of value. For example, in countries like India, if surface area of the single, largest, and undivided piece of banknote is less than 40%, the banknote is de-monetized and assumed to be of zero-value, even if it is genuine. As a result, unfit items having value are deemed risky and are either returned as zero value banknotes to the user or impounded. Users experience roughly a 15% rejection rate of legitimate (but unfit) notes to protect against acceptance of a trace level of unfit and zero value notes introduced by other users. This high rejection rate adds to the frustration of users having legitimate, albeit unfit, notes. Additionally, the electronic transaction systems are mechanically incapable of handling vast number of rejections. The poor condition of banknotes, however, increases the probability of rejections. In turn, the number of rejections has a negative consequence on jam rates.

### SUMMARY

This summary is provided to introduce concepts related to a system and method to adaptively accept one or more items of value. The concepts are further described below in the detailed description, drawings and claims. This summary is not intended to identify essential features of the claimed subject matter nor is it intended for use in determining or limiting the scope of the claimed subject matter.

In one example implementation, a system to accept one or more items of value is described. The item of value can be at least one of a banknote, a bill, a coupon, a security paper, a check, a valuable document, a coin, a token, and a gaming chip. The system can include a processor, and a memory coupled to the processor. The memory can include one or more modules, such as a classification module and a scoring module. The classification module can be configured to classify at least one item of value into at least one class in response to a user activity. The class can be one of an unrecognizable class, suspect counterfeit class, unfit class, fit and genuine class, and unfit and genuine class. The classification module can be further configured to implement one of Mahalanobis distance, Support Vector Machine, and/or Linear Discriminant Analysis to classify the inserted item of value.

The scoring module can be configured to determine an acceptance score based at least on transactional data and associate an action with the user activity, corresponding to the acceptance score. For example, the action may be to provide pending credit to the user until an inserted item of value is evaluated. Alternatively, the scoring module can assign a predetermined acceptance score based at least on the transactional data. Further, the action assigned by the scoring module may override another action assigned by the classification module. The transactional data can include at least one of time of transaction, geographical location of the system, user transaction history, user profile, user behavior, and/or environmental data.

The system can also include a monitoring module configured to: track at least one of transaction request, transactional data, and acceptance score at predefined time intervals; and compare the transactional data and the acceptance score with an expected pattern. If the acceptance score is different from the expected pattern, the monitoring module generates at least one of a notification, an alarm, a report, and a flag.

The system can further include at least one server having a knowledge database to provide the transactional data, and at least one handling system communicatively coupled to the server, to receive the item of value. Examples of the handling system include, but are not limited to, a vending machine, an automatic teller machine, a gaming machine, a currency validator, and a bill validator.

In another example implementation, a method to adaptively accept an item of value is described. The item of value can be at least one of a banknote, a bill, a coupon, a security paper, a check, a valuable document, a coin, a token, and a gaming chip.

The method can include receiving at least one item of value in response to a user activity; and classifying the received item of value into at least one predetermined class. Mahalanobis distance, Support Vector Machine, and/or Linear Discriminant Analysis can be implemented to classify the received item of value.

Each of the classified items of value can be analyzed to obtain transactional data. The transactional data can comprise time of transaction, geographical location of the system, user transaction history, user profile, user behavior, and/or environmental data.

Further, an acceptance score can be determined for the classified item of value, based at least on the transactional data. Additionally or alternatively, an action can be associated with the user activity corresponding to the acceptance score.

The method can be implemented in one of a vending machine, an automatic teller machine, a gaming machine, a currency validator, a pay phone, a computer, and a hand-held device. The method also can include monitoring the acceptance scores and comparing the acceptance scores with a predefined pattern. Further, a notification, an alarm, and/or a report may be generated based on the comparison.

In another implementation, a method to identify an abnormal event is described. The method can include receiving a plurality of items of value in response to a user activity and, classifying the received items of value into at least one predetermined class. Further, the locations of the received items of value in a feature space can be determined. The locations can be analyzed with respect to a predetermined pattern, and one or more alerts can be generated based at least on the analysis. This may be helpful to determine whether the received items of value are of an unfamiliar type, for example, a new series of items of value that a handling system is not configured to read. The method can include determining whether the received items of value are fraudulent items of value.

Some example implementations described herein can provide a cost-effective way to accept item of value without implementing costly fitness sensors. The exemplary system and methods can provide a way to reward the honest consumers and isolate fraudsters. An adaptive acceptance factor can aid in rejecting risky items and accepting trustworthy items.

### BRIEF DESCRIPTION OF THE DRAWINGS

The detailed description is provided with reference to the accompanying figures. In the figures, the left-most digit(s) of a reference number identifies the figure in which the reference number first appears. The same numbers are used throughout the drawings to reference like features and components. For simplicity and clarity of illustration, elements in the figures are not necessarily to scale.

FIG. 1 illustrates an exemplary network environment having one or more handling systems for adaptively accepting at least one item of value, in accordance with an example implementation of the present subject matter.

FIG. 2 illustrates a handling system having a scoring module, according to an example implementation of the present subject matter.

FIG. 3 illustrates an exemplary method for classifying the items of value, in accordance with an example implementation of the present subject matter.

### DETAILED DESCRIPTION

A handling system configured to adaptively accept one or more items of value is disclosed herein. Examples of items of value include, but are not limited to, banknotes, bills, coupons, security papers, checks, valuable documents, coins, tokens, and gaming chips. The handling system can be implemented within any electronic transaction system, such as a vending machine, a gaming machine, an automatic teller machine, a pay phone, etc., and in general any equipment used in retail, gaming, or banking industry for sorting and evaluation of the item of value, hereinafter referred to as item(s).

The current item acceptance protocols assign finite limits and actions for item processing. In other words, the items are classified into one or more classes and sub-classes based on pre-determined definitions. The definitions demarcate strict boundaries according to which classification is performed. Accordingly, based on the classification of the item and pre-assigned actions for each class, the item is accepted, rejected, impounded, etc.

As an example, consider table 1 with classes, class definitions, and actions for banknotes. Similar definitions exist for banknotes around the world. Unfit notes are notes with one or more of, but not limited to, the following: soil, stain, graffiti, de-ink, tear, hole, mutilation, repair, ink or dye staining, crumples, limpness, fold, or folded corners. As shown in table 1, class 3 also includes some unfit banknotes that are returned to the user as “zero-value” banknotes even though the banknotes are legitimate.

TABLE 1

| | Sub- | | |
|---|---|---|---|
| Class | Class | Class Definition | Action |
| 4 | A | Genuine and fit banknotes | Can be used for re- |
| | | | circulation; credited |
| | | | to the user |
| 4 | B | Genuine and unfit banknotes | Cannot be used for |
| | | | re-circulation; |
| | | | credited to the user |
| 3 | — | Unfit (poor condition but legitimate, | Either return to the |
| | | finite value) items of value; also | user or withdraw |
| | | includes legitimate but zero value | from circulation; |
| | | banknotes | may be credited to |
| | | | the user |
| 2 | — | Suspect counterfeit banknotes; image | Impound and with- |
| | | and format recognized but one or | draw from circula- |
| | | more authentication features is not | tion; not credited to |
| | | detected or out of tolerance | the user |
| 1 | — | Objects not recognized banknotes | Return to the user |

On one hand, if all class 3 banknotes are accepted, then there is a risk of accepting “zero value” banknotes, which is not an acceptable outcome. On the other hand, rejecting all class 3 notes has negative consequences for jam rates. Thus, items that fall on the boundary or near the boundary of classes are more likely to be misclassified. Additionally, because the boundaries or limits are strict, some legitimate items of value tend to be rejected or impounded, adding to the frustration of the honest user. Additionally, operational issues such as jamming become more prominent.

To this end, embodiments described herein help create dynamic boundaries for acceptance of items of value based at least on transactional data. Examples of transactional data include time of transaction, geographical location of the electronic transaction system used for the transaction, user behavior, user profile, user history, and other environmental data, e.g. temperature, humidity, etc. In one implementation, the handling system receives a transaction request. For example, a user may receive a request to deposit items of value. The handling system then allows the user to input the items of value. The received items of value are bucketed into different classes or sub-classes based on pre-determined definitions, e.g., as described in table 1 above. The classification also provides information related to where the item of value resides within a feature space.

Based at least on the transactional data, the handling system determines an acceptance score for each transaction and uses the acceptance score to re-classify the item of value. Accordingly, handling system facilitates action based on the re-classification. Alternatively, a new action may be assigned corresponding to each acceptance score, regardless of the classification. In one example, the acceptance score is reflective of the trustworthiness of the transaction. Higher acceptance scores represent less risk, while lower scores indicate possible fraudulent transactions.

In an example, the transactional data includes at least one of user account number, user profile, user transaction history, history on the classes of items deposited by the user, etc. If the user has a good standing in terms of the nature of transaction, for example, if a user has never deposited a “zero value” note in an electronic transaction, then there is a high probability that the received note classified as, say a high-risk class 3, is a legitimate but unfit note carrying full value. In this case, the handling system can alter the score, accept the banknote and provide full credit or pending credit to the user. However, if the user has a history of depositing “zero value” notes, the handling system alters the acceptance score, rejects or impounds the banknote and refuses any credit to the user in lieu of the received banknote. Additionally, the handling system can include a monitoring module to monitor the acceptance score over time. If the acceptance score falls below a predetermined threshold level, or fluctuates/deviates or varies over a period of time in a manner exceeding a predetermined pattern, the monitoring module can trigger events such as alarms, notifications, flags, reports or the like, indicating abnormality in transactions. The events may be sent to a system administrator via a communication network, such as internet, GSM, etc.

In another example, the transactional data includes at least one of the location of the electronic transaction system, time of the transaction, etc. In one implementation, the handling system is configured to perform a blanket change in acceptance scores based on time of the day, or location of the electronic transaction system. For example, it may be determined that the electronic transaction systems are more likely to receive risky notes during night than day. In this case, the scores may be temporarily altered, thereby making the class definitions very stringent. In another example, some locations may have a higher tendency of receiving risky notes. Accordingly, the acceptance scores may be adapted for such locations to decrease the likelihood of accepting risky notes. Thus, the acceptance score is adapted based on the nature of transactions. The acceptance scores are stored in a database and may be analyzed at predetermined time intervals.

In another implementation, the feature space is used to analyze the locations of a plurality of items inserted in the transaction system. Such items may have been inserted either sequentially or over a period of time. If the locations of the inserted items in the feature space do not match a pattern, an alert may be generated indicating abnormal behavior and subsequently, the operator may perform corrective actions. For example, the locations of the inserted item may follow a linear pattern or may all be on the boundary of a particular class. Such non-random behavior generally indicates fraud or a new type of item. Thus, it is of interest to generate alerts when either of such scenarios surface.

While aspects of the described classification of the item of value can be implemented in any number of different systems, environments, and/or configurations, the embodiments are described in the context of the following exemplary system(s). The descriptions and details of well-known components are omitted for simplicity of the description. It will be appreciated by those skilled in the art that the words during, while, and when as used herein are not exact terms that mean an action takes place instantly upon an initiating action but that there may be some small but reasonable delay, such as a propagation delay, between the initial action, and the reaction that is initiated by the initial action.

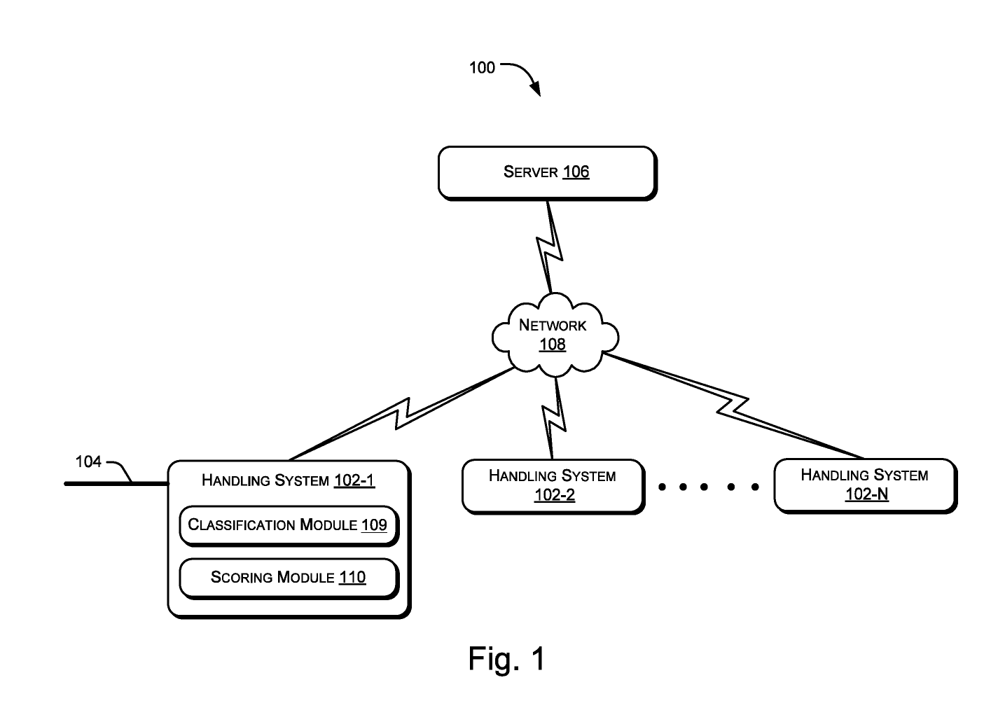

FIG. 1 illustrates a system 100 having one or more handling systems 102 for adaptively accepting items of value 104, according to an implementation of the present subject matter. In said implementation, a server 106 interacts with one or more handling systems 102-1, 102-2, . . . , 102-N, collectively referred to as handling systems 102, through a network 108. The network 108 may be a wireless network, wired network or a combination thereof. Network 108 can be implemented as one of the different types of networks, such as intranet, local area network (LAN), wide area network (WAN), the internet, and such. Network 108 may be either a dedicated network or a shared network, which represents an association of the different types of networks that use a variety of protocols, for example, Hypertext Transfer Protocol (HTTP) and Transmission Control Protocol/Internet Protocol (TCP/IP), to communicate with each other. The handling system 102 can interact with each other via network 108 or a peer-to-peer network (not shown in the figure).

In one implementation, handling system 102 can be any hardware or software or any combination thereof, which may be configured to adaptively accept items of value 104, such as currency, coupons, checks, tokens, gaming chips, security documents, banknotes, coins, vouchers, and the like. Examples of handling system 102 include, but are not limited to, an automatic transaction machine (ATM), a pay phone, a gaming machine, a kiosk, a bill acceptor, or a vending machine. In another implementation, handling system 102 can be implemented within any computing device, such as a hand-held device, laptop, and a desktop computer configured to adaptively accept items of value 104, hereinafter referred to as items 104, for a variety of applications known in the art. Handling system 102 may operate in both an offline and online mode.

In one implementation, handling system 102 includes a classification module 109 and a scoring module 110. Handling system 102 receives one or more items 104 in response to user activity, such as a deposit transaction. The classification module 109 classifies the received items 104 into one or more classes and sub-classes based on one or more classification techniques including, but not limited to, Mahalanobis distance, Linear Discriminant Analysis, and Support Vector Machine. Classification module 109 also provides information on the location of the item 104 in the feature space, which helps to determine if the item 104 is near or at the boundary of a plurality of classes or sub-classes.

In said implementation, scoring module 110 extracts transactional data from the transaction and associates an acceptance score with each transaction. In one implementation, acceptance score is based at least on transactional data, such as time of transaction, geographical location of handling system 102, user profile, and user transaction history, etc. Scoring module 110 may re-classify the item 104 based at least on the acceptance score. The new class may be same or different from the previously assigned class or sub-class.

Handling system 102 communicates with server 106 to determine action associated with the class to which the item 104 belongs. The actions may be favorable or unfavorable to the user and are based at least on the acceptance score. The server 106 may include a knowledge database (not shown) to store rules for accepting items 104. In other words, the relationship between acceptance scores and actions can be stored in knowledge database. Alternatively, the rules can be stored locally onto each of the handling systems 102 or within a dedicated repository (not shown in figure) external to the server 106.

The operational details are described in detail in subsequent paragraphs.

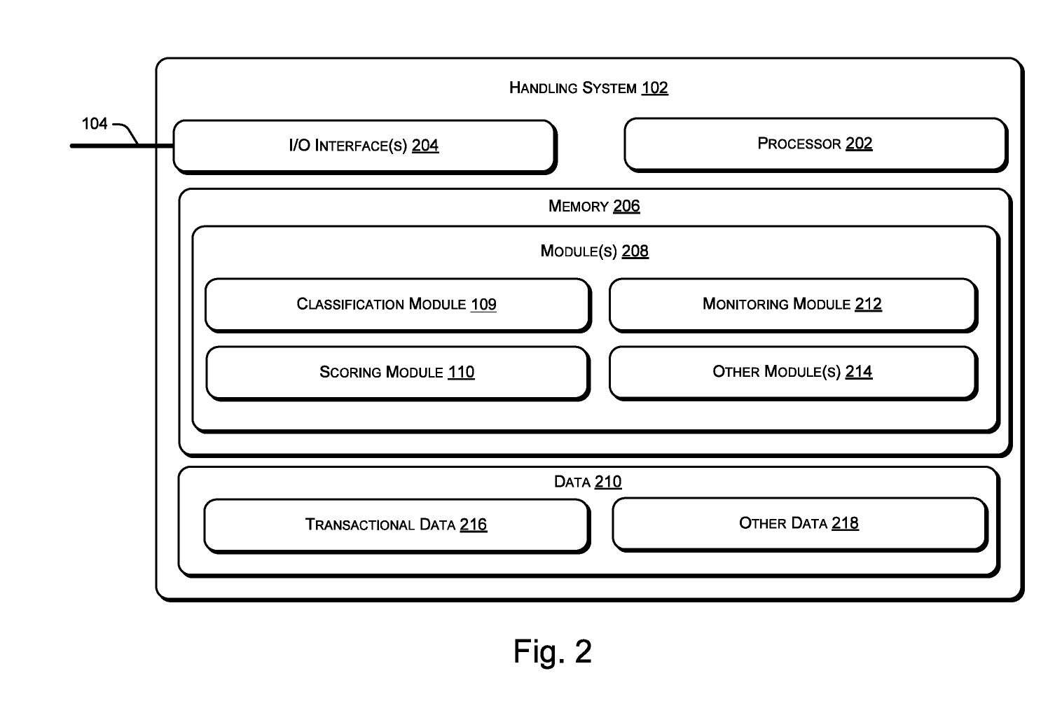

FIG. 2 illustrates a handling system 102 having a scoring module, according to an example implementation of the present subject matter. The handling system 102 can be an automatic transaction machine (ATM), a pay phone, a gaming machine, a kiosk, a bill acceptor, or a vending machine. In one implementation, handling system 102 can be any hardware or software or any combination thereof, which may be configured to adaptively accept items 104, such as currency, coupons, checks, tokens, gaming chips, security documents, banknotes, coins, vouchers, and the like.

In an implementation, handling system 102 includes a processor 202, interface(s) 204, and a memory 206 coupled to the processor 202. The processor 202 can be a single processing unit or a number of units, all of which could also include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 206.

Interface(s) 204 may include a variety of software and hardware interfaces, for example, interface for peripheral device(s), such as a keyboard, a mouse, an external memory, camera, and a printer. Further, interface 204 includes an input for receiving one or more items 104. Optionally or additionally, handling system 102 may include an output for ejecting items 104. Furthermore, there may be a single entry and exit point for receiving and ejecting items 104.

Memory 206 may include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 also includes module(s) 208 and data 210.

Module(s) 208 can include routines, programs, objects, components, data structures, etc., which perform particular tasks or implement particular abstract data types. In one implementation, the module(s) 208 include classification module 109, a scoring module 110, a monitoring module 212, and other module(s) 214. It will be appreciated that each of the module(s) 208 can be implemented as a combination of one or more different modules. Other module(s) 214 include programs that supplement applications or functions performed by handling system 102. Data 210 serves, amongst other things, as repository for storing data pertinent to functioning of modules 208. Data 210 includes transactional data 216 and other data 218.

In operation, handling system 102 receives and subsequently approves a request from a user to perform a transaction, for example a deposit transaction. A transport module within other modules 214 receives items 104 inserted by the user. Transport module includes a series of belts, rollers, or the like driven by an actuator (not shown) to cause items 104 to move in an inward or outward direction relative to the input and output of the handling system 102. Further, the transport module is operatively coupled to one or more storage units, recyclers, etc., that store items 104 for dispensing, re-circulation or evaluation.

To determine authenticity of inserted item 104, classification module 109 includes one or more sensors (not shown), for example electromagnetic sensors, optical sensors, impact sensors, and acoustic sensors. Further, classification module 109 analyzes each received item 104 to classify item 104 into one or more predetermined classes and/or sub-classes. Examples of classes include unrecognizable class, suspect counterfeit class, unfit (zero valued and finite valued items) class, and genuine class. The classes can have one or more sub-classes, for example, the genuine class can have sub-classes such as fit and genuine sub-class, and unfit and genuine sub-class, both of which provide credit to user. However, some items 104 lie on or near the boundary of two classes or sub-classes. Additionally, some places or machines have a minimal probability of receiving unacceptable items 104. In all such cases, classification module 109 is typically configured to classify item 104 in a class less favorable to the user making the overall experience for the user negative. For example, an unfit and genuine item 104, such as a banknote, is more likely to be classified as a zero-valued unfit item 104 and returned back to user.

For this reason, scoring module 110 tracks user activity, such as transaction request by user, and extracts transactional data 216 at least from the transaction. In another implementation, the transactional data 216 can be accessed internally or externally from within a repository (not shown in the figure). Transactional data 216 includes, but is not limited to, time of transaction, geographical location of the handling system 102 used for the transaction, user preferences, user profile, user transaction history, and other environmental data. In one implementation, scoring module 110 computes an acceptance score based at least on one or more transactional data 216 and associates the computed acceptance score with the transaction. The acceptance scores are stored in other data 218. The acceptance scores indicate the trustworthiness of transaction, even if user profile is unknown. For example, high acceptance scores may indicate a low-risk transaction, while low acceptance scores may indicate a high-risk transaction. Other implementations are also possible as will be understood by a person skilled in the art.

In an example, scoring module 110 can be configured to assign a predetermined score to all transactions occurring during a desired time-period or at a desired location. Thus, locations that have a history of receiving counterfeit items 104 can be flagged as high-risk. Accordingly, transactions originating from such locations can be tagged with low acceptance scores. In another example, scoring module 110 can be configured to identify the user and adapt scores according to the user's transaction history or profile. Thus, handling system 102 provides a positive user experience to users with a good moral standing even in locations that are otherwise risky. For first time users, a positive or a predetermined average score can be assigned, which is then adapted based on their transactions.

In an implementation, scoring module 110 re-classifies items 104 based on the computed acceptance scores. The new classification by scoring module 110 may be similar to or different from the classification performed by classification module 109. Additionally, classification by scoring module 110 does not simply adhere to any strict definitions of classes, and adds flexibility to the classification. Scoring module 110 may have access to a knowledge base providing a list of actions associated with the newly defined classes. Alternatively or additionally, the acceptances scores may be associated with a specific action, such as for example reject, accept, impound, provide immediate credit, provide pending credit, etc. In one implementation, the actions provided by scoring module 110 override the actions dictated by classification module 109. In another implementation, an operator in a remote location can make real-time choices with regard to actions. Additionally or optionally, the operator may validate the scores at predefined time intervals. Until then, handling system 102 may provide a temporary action, such as pending credit, to the user.

In another example implementation, instead of performing real-time evaluation of scores based on transactional data 216 of the current transaction, scoring module 110 relies on past transactions or user history. In this case, transactional data 216 from the past transactions is obtained and an acceptance score is assigned. If no history is available, scoring module 110 assigns default scores to the current transaction. Additionally, transactional data 216 from current transaction may be obtained and stored in data 210 for further evaluation. Human operators may provide a more accurate acceptance score for future transactions based on evaluation performed on the accepted or impounded items 104 at a later stage. Additionally, items 104 may be traced to a user especially in cases where the user has a history of depositing counterfeit or high-risk items 104.

In an example implementation, handling system 102 can also include monitoring module 212. Monitoring module 212 tracks transactions requests, transactional data 216, and acceptance scores either constantly or at predefined time intervals. Monitoring module 212 then compares such data with a stored pattern or a threshold level to determine possible gaps and abnormalities in transaction. For example, if the acceptance score falls below a predetermined threshold level, or varies over a period of time in a manner exceeding the predetermined pattern, monitoring module 212 can trigger events such as alarms, notifications, flags, and generate reports or the like, for operator's attention. The events may be sent to the operator via one or more communication devices such as hand-held device or computer over a communication network, such as internet, GSM, etc. The reports may also be sent to the operator for trend analysis and revisions to the knowledge base, if desired. Such reports may also be generated from data accumulated from a plurality of handling systems 102, say those in a geographical region.

In yet another example implementation, monitoring module 212 is communicatively coupled with one or more sensors (not shown in the figure) to record fraudulent activities, such as banknote stringing, fishing or other mechanical attacks, in the handling system 102 or neighboring handling systems 102. This information is also classified as transactional data 216 and can be sent to scoring module 110 to alter acceptance scores for the specific handling system 102. For example, if such a fraudulent activity occurs, the scoring module 110 can disable the system 100 or report to a system operator.

In one example implementation, the monitoring module 212 analyzes the feature space and the locations of a plurality of items inserted in the transaction system within the feature space. Such items may have been inserted either sequentially or over a period of time. The monitoring module 212 is configured to compare the locations of the inserted items in the feature space with a predefined pattern. Accordingly, an alert may be generated indicating abnormal behavior and subsequently, the operator may perform corrective actions. For example, the locations of the inserted items may follow a linear pattern, the locations may all be on the boundary of a particular class, or the locations may all be next to each other like a cluster. Such non-random behavior generally indicates fraud or a new type of item. Thus, the monitoring module 212 generates one or more alerts indicating abnormal events. If a new type of item is inserted, the alerts can also trigger the system 100 to collect relevant data for the future.

In another example implementation, scoring module 110 obtains the transactional data 216 based on the user activity, such as a request for transaction, and subsequently computes an acceptance score. The classification module 109, communicatively coupled to the scoring module 110, then performs a classification of the inserted item 104 based on the acceptance score. Thus, the classification boundaries are more flexible than those set by traditional classification techniques, enabling the inserted item 104 to be classified more flexibly and on an item-by-item basis

Prior art solutions suggest shrinking and widening the window of acceptance of items 104 but in solutions described herein, the boundaries still remain discrete and fixed, allowing exceptions for transactions that are more likely to be legitimate. This is particularly useful for locations and users, such as poor workers, small merchants, etc., dealing with unfit items 104, most of which are genuine. The conventional systems and algorithms demonetize items 104 originating at such locations and from such users. This causes users to alienate themselves from such handling systems 102. In the long run, this has a negative impact on the country's economy. The embodiments described herein provide a continuum of classification boundaries thus allowing positive user experience and better access to finance for honest users. Alternatively, fraudulent users or locations that have a tendency to receive risky notes are discouraged.

Further, in the adaptive handling system 102 described herein, users “earn” trust of having even marginal risk legitimate items 104 and “lose” trust if zero value items 104 are accepted. In an example, users depositing unfit but genuine notes have a better acceptance score than users depositing unfit but zero value notes. In another example, a user in a casino gaming environment may be known via a player tracking system, giving trusted players the benefit of having marginal notes accepted.

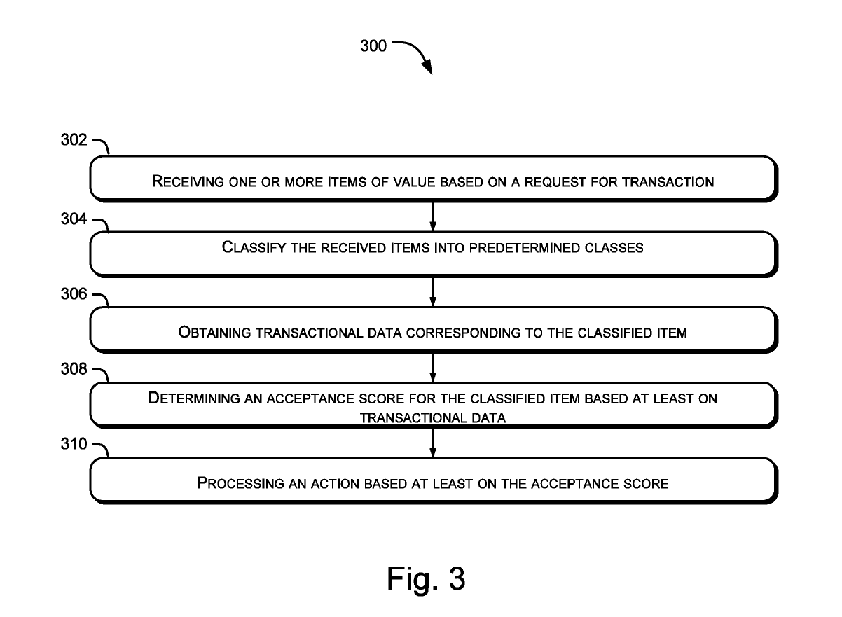

FIG. 3 illustrates an exemplary method 300 for accepting one or more items 104 in handling system, in accordance with an example implementation of the present subject matter. Method 300 is described in the context of banknotes; however, method 300 may be extended to cover other kinds of items 104, such as coins, tokens, checks, etc. Additionally, even though the method is described in the context of handling system 102 for determining acceptance factor of an item 104, the method is also implementable on other applications as will be understood by a person skilled in the art. Herein, some embodiments are also intended to cover program storage devices, for example, digital data storage media, which are machine or computer readable and encode machine-executable or computer-executable programs of instructions, wherein said instructions perform some or all of the steps of the described method. The program storage devices may be, for example, digital memories, magnetic storage media such as a magnetic disks and magnetic tapes, hard drives, or optically readable digital data storage media.

The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof.

At least one item of value 104 can be received at 302. In an implementation, a request for a transaction can be received. Examples of transactions can include deposit and/or withdrawal of one or more items 104, such as coins, banknotes, coupons, tokens, security documents, etc. In an example, a user may input account information to request the transaction. Alternatively, a user may swipe a card to initiate a transaction, such as deposit or withdraw items 104. Subsequently, items 104 can be received via a transport path.

Received items 104 can be classified into at least one pre-determined class at 304. During the transport of the item 104, classification module 109 can sense the presence of item 104 and obtain sensor data for classification of item 104 into one of multiple classes and sub-classes. The classification can be based on one or more classification techniques including, but not limited to, Mahalanobis distance, Linear Discriminant Analysis, Support Vector Machine, and Support Vector Machine.

Thus, classification module 109 can classify an inserted item 104 as a valid banknote of a known denomination, a valid banknote of a known denomination in poor condition (e.g., not fit for circulation), a suspect counterfeit banknote, or soiled or damaged banknote. Classification module 109 also can provide information on the location of the item 104 in the feature space, which helps to determine if the item 104 is near or at the boundary of two classes or sub-classes.

Transactional data 216 corresponding to the classified item 104 can be obtained at 306. For example, if the classification module 109 determines that the item 104 belongs to class 4, the scoring module 110 obtains transactional data 216 related to the item 104 from one or more sources. The transactional data 216 can include, but is not limited to, time of the transaction, the geographical location of handling system 102 used for the transaction, user preferences, user profile, user transaction history, and the like.

An acceptance score can be determined at 308 for the classified item 104 based at least on transactional data 216. In one implementation, scoring module 110 computes an acceptance score based at least on one or more transactional data 216 and associates the computed acceptance score with the transaction. The acceptance score can indicate the risk of the transaction.

An action can be processed based at least on the acceptance score at 310. In an implementation, the acceptance score can determine a new classification of the classified item 104, which may be different from or similar to the previous classification. Accordingly, the scoring module 110 can associate an action. For example, if a user performs a transaction from a handling system 102 placed in a low risk environment, e.g., office, and the user inserts a low-risk item 104, scoring module 110 varies the score, and accepts item 104. However, in a high-risk environment, even a low-risk item 104 may be rejected as per pre-defined rules. Thus, each acceptance score may be associated with a corresponding action. Such relationships may be defined in a knowledge base within an external server 106 or internally within handling system 102.

Alternatively, scoring module 110 can determine whether the score is within the predefined range. If it is determined that the score meets a threshold level, transaction request can be processed. In another implementation, transaction request may be put in a queue, for example pending credit may be provided until further validation is performed. However, if it is determined that the score does not meet a threshold level, the request can be rejected.

In yet another implementation, a monitoring module 212 monitors transactions requests, transactional data 216, and acceptance scores either constantly or at predefined time intervals. The data can be compared with an expected pattern or distribution to determine possible gaps and abnormalities in transaction. For example, if the acceptance score falls below a predetermined threshold level, or varies over a period of time in a manner exceeding the predetermined pattern, monitoring module 212 can trigger events such as alarms, notifications, flags, reports or the like, for operator's attention.

Further, the acceptance score obtained at 308 can be stored and saved in transactional data 216 with other parameters. In this manner, a user or the transaction can be profiled to better assist in requests such as deposit or withdraw media. Further, the scores can be adaptively configured on a transaction-to-transaction basis, thus rewarding the honest users and providing better ways to handle frauds.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Although embodiments for a system to accept items of value have been described in language specific to structural features and/or methods, it is to be understood that the invention is not necessarily limited to the specific features or methods described. Rather, the specific features and methods are disclosed as exemplary embodiments for the system to accept items of value.

1. A system comprising:
at least one data processor; and
a memory coupled to the at least one data processor, wherein the memory comprises:
a classification module configured to classify at least one item of value into at least one class in response to a user activity; and
a scoring module configured to,
determine an acceptance score based at least on transactional data; and
associate, based on the acceptance score, an action with the user activity.

2. The system as claimed in claim 1, wherein the transactional data comprises at least one of time of transaction, geographical location of the system, user transaction history, user profile, user behavior, and environmental data.

3. The system as claimed in claim 1, wherein the at least one class is at least one of an unrecognizable class, a suspect counterfeit class, an unfit and zero valued class, an unfit and finite valued class, a fit and genuine class, and an unfit and genuine class.

4. The system as claimed in claim 1, wherein the scoring module is further configured to assign a predetermined acceptance score based at least on the transactional data.

5. The system as claimed in claim 1, wherein the action assigned by the scoring module overrides another action assigned by the classification module.

6. The system as claimed in claim 1 further comprising a monitoring module configured to:
track at least one of a transaction request, the transactional data, and the acceptance score at predefined time intervals; and
compare the transactional data and the acceptance score with an expected pattern;
if the acceptance score is different from the expected pattern, generate at least one of a notification, an alarm, a report, and a flag.

7. The system as claimed in claim 1, wherein the classification module is further configured to implement one of Mahalanobis distance, Support Vector Machine, and Linear Discriminant Analysis to classify the at least one item of value.

8. The system as claimed in claim 1, wherein the at least one item of value is at least one of a banknote, a bill, a coupon, a security paper, a check, a valuable document, a coin, a token, and a gaming chip.

9. The system as claimed in claim 1 further comprising:
at least one server having a knowledge database to provide the transactional data; and
at least one handling system communicatively coupled to the at least one server, wherein the at least one handling system is configured to receive the at least one item of value.

10. The system as claimed in claim 9, wherein the at least one handling system is one of a vending machine, an automatic teller machine, a gaming machine, a currency validator, and a bill validator.

11. A method to adaptively accept an item of value comprising:
receiving at least one item of value in response to a user activity;
classifying the received item of value into at least one predetermined class;
obtaining transactional data corresponding to the classified item of value;
determining an acceptance score for the classified item of value, based at least on the transactional data; and
associating, based on the acceptance score, an action with the user activity.

12. The method as claimed in claim 11 further comprising implementing one of Mahalanobis distance, Support Vector Machine, and Linear Discriminant Analysis to classify the received item of value.

13. The method as claimed in claim 11, wherein the method is implemented in one of a vending machine, an automatic teller machine, a gaming machine, a currency validator, a pay phone, a computer, and a hand-held device.

14. The method as claimed in claim 11, wherein the item of value is at least one of a banknote, a bill, a coupon, a security paper, a check, a valuable document, a coin, a token, and a gaming chip.

15. The method as claimed in claim 11, wherein the transactional data comprises at least one of time of transaction, geographical location of the system, user transaction history, user profile, user behavior, and environmental data.

16. The method as claimed in claim 11 further comprising monitoring the acceptance score and comparing the acceptance score with a predefined pattern.

17. The method as claimed in claim 16 further comprising generating at least one of a notification, an alarm, and a report based on the comparison.

18. A method comprising:
receiving a plurality of items of value in response to a user activity;
classifying the received items of value into at least one predetermined class;
determining locations of the received items of value in a feature space;
analyzing the locations with respect to a predetermined pattern; and
generating an alert at least based on the analysis, wherein the alert indicates at least one abnormal event.

19. The method as claimed in claim 18, wherein analyzing includes determining whether the received items of value are of an unfamiliar type, and wherein a new series of items of value is an unfamiliar type.

20. The method as claimed in claim 18, wherein analyzing includes determining whether the received items of value are fraudulent items of value.

21. The method as claimed in claim 18, wherein analyzing includes determining whether the locations follow a non-random pattern.

22. A method comprising:
obtaining transactional data in response to a user activity;
determining an acceptance score based on the transactional data; and
classifying at least one item of value based at least on the acceptance score, wherein the user activity includes inserting the at least one item of value.

23. The method as claimed in claim 22, wherein the acceptance score is indicative of risk associated with the user activity.

24. The method as claimed in claim 22, wherein the transactional data comprises at least one of time of transaction, geographical location of the system, user transaction history, user profile, user behavior, and environmental data.
